(19) United States
(12) Patent Application Publication
(10) Pub. No.: US 2026/0085550 A1
(43) Pub. Date: Mar. 26, 2026

(54) DELIVERY ROBOT AND DELIVERY METHOD USING THE SAME

(71) Applicant: SAMSUNG ELECTRONICS CO., LTD., Suwon-si (KR)

(72) Inventor: Kuemjong Bae, Suwon-si (KR)

(73) Assignee: SAMSUNG ELECTRONICS CO., LTD., Suwon-si (KR)

(21) Appl. No.: 19/404,742

(22) Filed: Dec. 1, 2025

Related U.S. Application Data
(63) Continuation of application No. PCT/KR2024/006156, filed on May 8, 2024.

(30) Foreign Application Priority Data
Jun. 1, 2023 (KR) 10-2023-0070710

(51) Int. Cl. E05B 65/463; B60P 3/00; B65G 1/137; E05B 47/00; G05D 1/229; G05D 101/00; G05D 105/28

(52) U.S. Cl. CPC E05B 65/463; B60P 3/007; B65G 1/1371; E05B 47/0012; G05D 1/229; E05B 2047/0017; E05B 2047/002; E05B 2047/0023; G05D 2101/22; G05D 2105/28

(57) ABSTRACT

A delivery robot includes a moving body; an upper body on an upper surface of the moving body; a plurality of drawers vertically stacked at one side of the upper body; a drawer locking device configured to collectively lock each of the plurality of drawers and selectively unlock any one drawer of the plurality of drawers while keeping locked other drawers of the plurality of drawers; and a processor configured to control the moving body and the drawer locking device.

### CROSS-REFERENCE TO RELATED APPLICATIONS

This application is a continuation of International Application No. PCT/KR2024/006156, filed on May 8, 2024, which is based on and claims priority to Korean Patent Application No. 10-2023-0070710, filed on Jun. 1, 2023, in the Korean Intellectual Property Office, the disclosures of which are incorporated by reference herein in their entireties.

### BACKGROUND

### 1. Field

The disclosure relates to a delivery robot, and more particularly, to a delivery robot including a plurality of drawers and a delivery method using the delivery robot.

### 2. Description of Related Art

As robotics technology advances, robots for various purposes are being developed and used.

For example, cleaning robots that clean floors in specific areas, delivery robots that deliver objects, serving robots that carry food in restaurants and cafes, and guide robots that guide customers are being used.

In the case of delivery robots, a single supplier may deliver objects to multiple customers. To achieve this, the delivery robot may include a plurality of drawers.

These drawers may store multiple objects requested by multiple customers. The delivery robot may then use these drawers to deliver multiple objects to multiple customers.

### SUMMARY

According to an aspect of the disclosure, a delivery robot may include: a moving body; an upper body on an upper surface of the moving body; a plurality of drawers vertically stacked at one side of the upper body; a drawer locking device configured to collectively lock each of the plurality of drawers and selectively unlock any one drawer of the plurality of drawers while keeping locked other drawers of the plurality of drawers; and a processor configured to control the moving body and the drawer locking device.

The drawer locking device may include: a plurality of locking protrusions on side surfaces of the plurality of drawers; a locking plate facing the side surfaces of the plurality of drawers and including a plurality of locking portions configured to selectively lock and selectively unlock the plurality of locking protrusions; and a moving part configured to move the locking plate in a vertical direction with respect to the plurality of drawers.

Each of the plurality of locking portions of the locking plate may include: a moving hole formed as an elongated hole that receives a corresponding locking protrusion among the plurality of locking protrusions and allows the locking plate to move in the vertical direction with respect to the plurality of locking protrusions; and a selection opening formed at one side of the moving hole and through which the corresponding locking protrusion passes, and distances from bottom ends of the moving holes of the plurality of locking portions to the selection openings thereof are different from each other.

The distances, from the bottom ends of the moving holes of the plurality of locking portions to the selection openings thereof, may include a longest distance, from a lowermost bottom end of the moving hole to the selection opening of a lowermost locking portion located at a bottom of the plurality of locking portions, and a shortest distance from an uppermost bottom end of an uppermost moving hole to the selection opening of a uppermost locking portion located at a top of the plurality of locking portions, the bottom of the plurality of locking portions being of a closest locking portion, of the plurality of locking portions, to the moving body, and the top of the plurality of locking portions being of a furthest locking portion, of the plurality of locking portions, from the moving body.

The moving holes of the plurality of locking portions may include blocking grooves at the bottom ends of the moving holes and configured to block the plurality of locking protrusions from moving, and the moving part may be configured to move the locking plate in the vertical direction with respect to the plurality of drawers and collectively lock each of the plurality of drawers by arranging, by moving the locking plate in the vertical direction until the plurality of locking protrusions at the blocking grooves of the moving holes of the plurality of locking portions.

The moving holes of the plurality of locking portions include overall openings formed at tops of the moving holes and through which the plurality of locking protrusions are configured to pass, and the moving part is configured to move the locking plate in the vertical direction with respect to the plurality of drawers and collectively unlock each of the plurality of drawers by arranging, by moving the locking plate in the vertical direction, until the plurality of locking protrusions are located in the overall openings of the moving holes of the plurality of locking portions.

The moving part may include: a guide member configured to guide linear movement of the locking plate; and a driving unit configured to move the locking plate in the vertical direction.

The driving unit may include: a rack gear on one side of the locking plate; a pinion meshed with the rack gear; and a motor configured to rotate the pinion.

The driving unit may include: a ball screw on one side of the locking plate; and a motor configured to rotate the ball screw.

The guide member may include a rail.

The delivery robot may further include: a plurality of additional drawers vertically stacked at an opposite side of the upper body, the opposite side of the upper body being opposite to the side of the upper body at which the plurality of drawers are disposed; and an additional drawer locking device configured to collectively lock each of the plurality of additional drawers and selectively unlock any one additional drawer of the plurality of additional drawers while keeping locked other additional drawers of the plurality of additional drawers.

The delivery robot may further include: a user interface provided on a front of the upper body; and a memory configured to store a plurality of open codes corresponding to the plurality of drawers, and the processor may be configured to, based on an open code being input through the user interface, determine whether the open code is included in the plurality of open codes stored in the memory, and
based on the open code being included in the plurality of open codes, operate the moving part to unlock the one drawer of the plurality of drawers corresponding to the open code.

Each of the plurality of locking protrusions may have a same size as each other.

According to an aspect of the disclosure, a delivery method using a delivery robot including a plurality of drawers, may include: a) transmitting a different open code of a plurality of open codes to each customer of a plurality of customers; b) moving, the delivery robot, to one of the plurality of customers; c) checking, by the delivery robot, whether an open code of the plurality of open codes has been input; d) operating, by the delivery robot, a drawer locking device of the delivery robot to unlock a drawer corresponding to the open code among the plurality of drawers and based on the open code being input; e) checking, by the delivery robot, whether the drawer, that is unlocked by operating the drawer locking device, is opened and closed; f) sequentially performing b) to e) until the delivery robot completes delivery to all of the plurality of customers; and g) returning, the delivery robot, to a predetermined position.

The drawer locking device may include: a plurality of locking protrusions on side surfaces of the plurality of drawers; a locking plate facing the side surfaces of the plurality of drawers and including a plurality of locking portions configured to selectively lock and selectively unlock the plurality of locking protrusions; and a moving part configured to move the locking plate in a vertical direction with respect to the plurality of drawers.

The transmitting the different code of the plurality of open codes to each of the plurality of customers may be performed by a server, and the server is configured to transmit location information of the plurality of customers to the delivery robot.

### BRIEF DESCRIPTION OF DRAWINGS

The above and/or other aspects, features, and advantages of certain embodiments of the disclosure will be more apparent from the following description taken in conjunction with the accompanying drawings, in which:

FIG. 1 is a perspective view illustrating a delivery robot according to one or more embodiments of the disclosure;

FIG. 2 is a functional block diagram of a delivery robot according to one or more embodiments of the disclosure;

FIG. 3 is a view illustrating a delivery system of a delivery robot according to one or more embodiments of the disclosure;

FIG. 4 is a cross-sectional view illustrating the delivery robot of FIG. 1 taken along line A-A;

FIG. 5 is a cross-sectional view illustrating the delivery robot of FIG. 1 taken along line B-B;

FIG. 6 is a perspective view illustrating a locking plate of a drawer locking device of a delivery robot according to one or more embodiments of the disclosure;

FIG. 7 is a view illustrating a drawer locking device of a delivery robot according to one or more embodiments of the disclosure;

FIG. 8A is a view illustrating a relationship between a locking plate and locking protrusions of a drawer locking device that allows a first drawer of a delivery robot to be opened according to one or more embodiments of the disclosure;

FIG. 8B is a perspective view illustrating a state in which the first drawer is opened when the drawer locking device of the delivery robot is in the state of FIG. 8A according to one or more embodiments of the disclosure;

FIG. 9A is a view illustrating a relationship between a locking plate 50 and locking protrusions of a drawer locking device 40 that allows a second drawer of a delivery robot 1 according to one or more embodiments of the disclosure to be opened;

FIG. 9B is a perspective view illustrating a state in which the second drawer is opened when the drawer locking device of the delivery robot is in the state of FIG. 9A according to one or more embodiments of the disclosure;

FIG. 10A is a view illustrating a relationship between a locking plate and locking protrusions of a drawer locking device that allows a third drawer of a delivery robot according to one or more embodiments of the disclosure to be opened;

FIG. 10B is a perspective view illustrating a state in which the third drawer is opened when the drawer locking device of the delivery robot is in the state of FIG. 10A according to one or more embodiments of the disclosure;

FIG. 11A is a view illustrating a relationship between a locking plate and locking protrusions of a drawer locking device that allows all drawers of a delivery robot according to one or more embodiments of the disclosure to be opened;

FIG. 11B is a perspective view illustrating a state in which all drawers are opened when the drawer locking device of the delivery robot is in the state of FIG. 11A according to one or more embodiments of the disclosure;

FIG. 12 is a view illustrating a delivery robot according to one or more embodiments of the disclosure including a plurality of drawers and a plurality of additional drawers; and

FIG. 13 is a flowchart illustrating a delivery method using a delivery robot according to one or more embodiments of the disclosure.

### DETAILED DESCRIPTION

Various embodiments of this document and terms used herein are not intended to limit the technical features described in this document to specific embodiments, but should be understood to include various modifications, equivalents, or alternatives of the embodiments.

In connection with the description of the drawings, similar reference numbers may be used for similar or related components.

The singular form of a noun corresponding to an item may include one or more of the above item, unless the relevant context clearly indicates otherwise.

In this document, each of phrases such as “A or B,” “at least one of A and B,” “at least one of A or B,” “A, B, or C,” “at least one of A, B, and C,” “at least one of A, B, C” may include any one of the items listed together with the corresponding phrase, or any possible combination thereof.

The term “and/or” includes any element of a plurality of related described elements or a combination of a plurality of related described elements.

Terms such as “first,” “second,” “primary,” or “secondary” may be used simply to distinguish one component from other components, and do not limit the corresponding components in other respects (e.g., importance or order).

When a component (e.g., a first component) is said to be “coupled” or “connected” to another component (e.g., a second component), with or without the terms “functionally” or “communicatively,” it means that the component can be connected to the other component directly (e.g., wired), wirelessly, or through a third component.

Terms such as “include” or “have” are intended to designate the presence of features, numbers, steps, operations, components, parts, or combinations thereof described in the embodiment, but do not preclude the presence or addition of one or more other features, numbers, steps, operations, components, parts, or combination thereof.

When a component is said to be “connected,” “coupled,” “supported,” or “in contact” with another component, this means not only cases where the components are directly connected, coupled, supported, or contacted, but also cases where the components are indirectly connected, coupled, supported, or contacted through a third component.

When a component is said to be located “on” other component, this includes not only cases where the component is in contact with the other component, but also cases where another component exits between the two components.

Further, terms such as ‘leading end’, ‘rear end’, ‘upper side’, ‘lower side’, ‘top end’, ‘bottom end’, etc. used in the disclosure are defined with reference to the drawings. However, the shape and position of each component are not limited by these terms.

Hereinafter, a delivery robot 1 according to one or more embodiments of the disclosure will be described in detail with reference to the attached drawings.

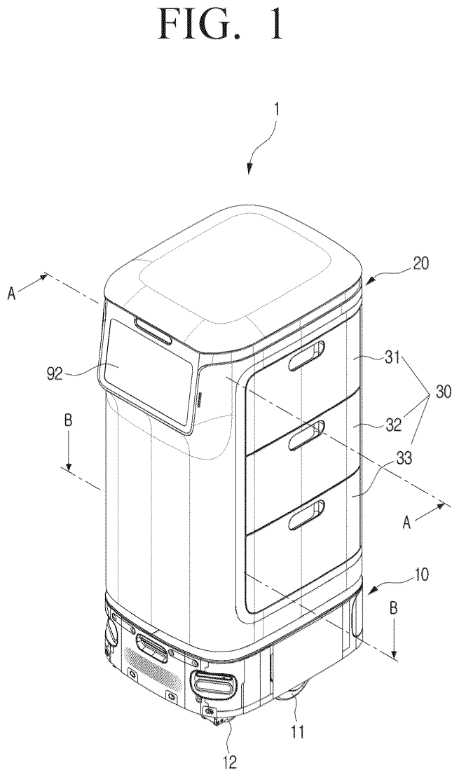

FIG. 1 is a perspective view illustrating a delivery robot 1 according to one or more embodiments of the disclosure.

Referring to FIG. 1, a delivery robot 1 according to one or more embodiments of the disclosure may include a moving body 10 and an upper body 20.

The moving body 10 may be configured to move the delivery robot 1 to a designated location. In other words, the delivery robot 1 may autonomously navigate to the designated location using the moving body 10.

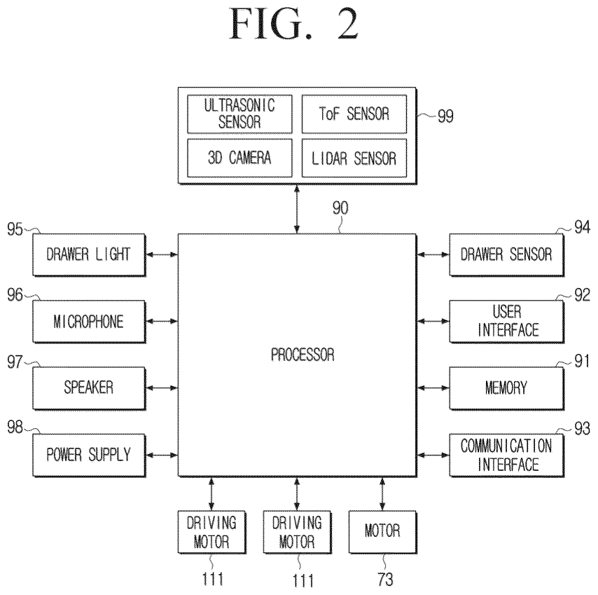

A processor 90 (e.g., FIG. 2), multiple sensors, and a power supply may be disposed inside the moving body 10 to control the delivery robot 1 to enable autonomous navigation.

The moving body 10 may include a pair of driving wheels 11 and a plurality of auxiliary wheels 12. The pair of driving wheels 11 and the plurality of auxiliary wheels 12 may be disposed on the lower surface of the moving body 10.

The pair of driving wheels 11 may be configured to move the delivery robot 1. The pair of driving wheels 11 may include a left driving wheel and a right driving wheel. The left driving wheel may be disposed on the left side of the lower surface of the moving body 10, and the right driving wheel may be disposed on the right side of the lower surface of the moving body 10. The left driving wheel and the right driving wheel may be disposed such that the rotation axes of the left and right driving wheels are aligned in a straight line.

The pair of driving wheels 11 may be configured to have the same structure. Each of the pair of driving wheels 11 may include a driving motor 111 and a wheel. The pair of driving wheels 11 may be detachably disposed on the lower surface of the moving body 10.

In this embodiment, the plurality of auxiliary wheels 12 may include four auxiliary wheels 12. The four auxiliary wheels 12 may include two front auxiliary wheels disposed in front of the pair of driving wheels 11 and two rear auxiliary wheels 12 disposed in the rear of the driving wheels 11.

In this embodiment, the moving body 10 is configured to be moved by wheels. However, the method of moving the moving body 10 of the delivery robot 1 according to one or more embodiments of the disclosure is not limited thereto. Various moving methods may be used as long as the moving body 10 can be moved.

The upper body 20 may be disposed on the upper surface of the moving body 10. The upper body 20 may be configured to accommodate a plurality of objects to be delivered to a plurality of customers. For example, the upper body 20 may include a plurality of drawers 30 for accommodating the plurality of objects.

The drawer 30 may be configured to accommodate objects. For example, the drawer 30 may be formed in a container shape with a rectangular bottom. A handle may be provided on the front of the drawer 30. A user may open and close the drawer 30 using the handle.

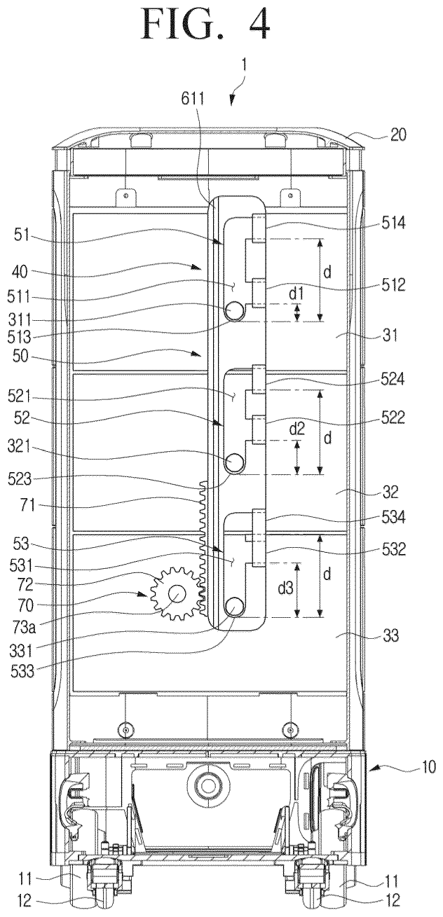

The upper body 20 may include a drawer locking device 40 (see FIG. 4) that selectively unlocks the plurality of drawers 30. For example, the drawer locking device 40 may be configured to unlock one selected drawer 30 among the plurality of drawers 30 and lock the remaining drawers 30. A detailed description about the drawer locking device 40 will be described later.

The upper body 20 may include a user interface 92. The user interface 92 may be disposed on the upper portion of the front of the upper body 20. The user interface 92 may be configured as a touch display. Accordingly, the user may input a code into the delivery robot 1 using the touch display.

FIG. 2 is a functional block diagram of a delivery robot 1 according to one or more embodiments of the disclosure.

Referring to FIG. 2, the delivery robot 1 according to one or more embodiments of the disclosure may include a processor 90.

The processor 90 may be configured to control the delivery robot 1 as a whole. For example, the processor 90 may be configured to control the moving body 10 and the drawer locking device 40 of the delivery robot 1. In detail, the processor 90 may control the moving body 10 to move the delivery robot 1 to a specific location, and may control the drawer locking device 40 at the location of arrival to enable one of the plurality of drawers 30 to be opened.

The processor 90 may be configured in various ways as long as it can control the delivery robot 1. For example, the processor 90 may be implemented as a microprocessor, a graphics-processing unit (GPU), an artificial intelligence (AI) processor, a neural processing unit (NPU), or a time controller (TCON). However, the processor 90 is not limited thereto, and may include one or more of a central processing unit (CPU), a micro controller unit (MCU), a micro processing unit (MPU), a controller, an application processor (AP), a communication processor (CP), and an advanced reduced instruction set computing (RISC) machine (ARM) processor or may be defined as a corresponding term. In addition, the processor 90 may be implemented as a system on chip (SoC) or a large scale integration (LSI) in which a processing algorithm is built therein, or may be implemented as an application specific integrated circuit (ASIC) type or a field programmable gate array (FPGA) type.

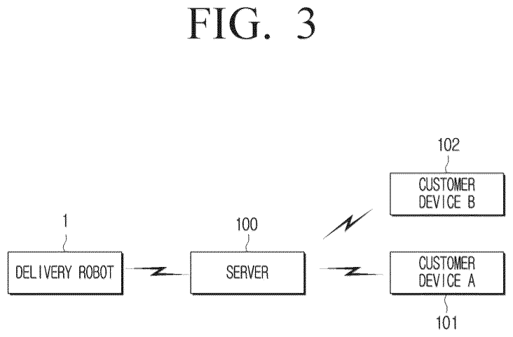

The delivery robot 1 may include a memory 91. The memory 91 may store information regarding the locations of the customers and the drawers 30 corresponding to open codes transmitted from a server 100 (see FIG. 3). For example, the memory 91 may store a plurality of open codes corresponding to a plurality of drawers 30 and a plurality of customer location information corresponding to a plurality of customers.

In addition, the memory 91 may store at least one instruction related to the delivery robot 1. The memory 91 may store an operating system (O/S) for driving the delivery robot 1. In addition, the memory 91 may store various software programs or applications for operating the delivery robot 1 according to one or more embodiments of the disclosure.

The memory 91 may include a semiconductor memory such as a flash memory and the like or a magnetic storage medium such as a hard disk and the like.

On the other hand, in this disclosure, the term memory 91 may be used to refer to a memory, a ROM within the processor, a RAM, or a memory card (e.g., a micro SD card, a memory stick) mounted on the delivery robot 1.

The processor 90 may be electrically connected to the memory 91 and control the overall operation of the delivery robot 1. For example, when the user inputs an open code using the user interface 92, the processor 90 may search for an open code identical to the input open code among a plurality of open codes stored in the memory 91 and operate the drawer locking device 40 to unlock the drawer 30 corresponding to the same open code.

The processor 90 may include one or multiple processors. For example, the processor 90 may perform an operation of the delivery robot 1 according to one or more embodiments of the disclosure by executing at least one instruction stored in the memory 91.

The delivery robot 1 may include a user interface 92. The delivery robot 1 according to an embodiment may use a touch display as the user interface 92. The delivery robot 1 may output the status of the delivery robot 1 through the touch display. In addition, the delivery robot 1 may receive user instructions through the touch display. For example, the delivery robot 1 may receive open codes input by the user through the touch display.

However, the user interface 92 used in the delivery robot 1 of the disclosure is not limited thereto. The user interface 92 may include various types of input devices. For example, the user interface 92 may include physical buttons. In this case, the physical buttons may include function keys, direction keys, and dial buttons. The physical buttons may be implemented as the plurality of keys.

The delivery robot 1 may include a communication interface 93. The delivery robot 1 may communicate with external devices, such as the server 100 (see FIG. 3), a mobile device, and the like, through the communication interface 93. The delivery robot 1 may receive customer location information transmitted from the server 100 through the communication interface 93.

The processor 90 may control the delivery robot 1 according to the instructions received through the communication interface 93.

The communication interface 93 may be implemented as wireless communication. For example, the communication interface 93 may be configured to perform communication using at least one of the following communication methods: Wi-Fi, Wi-Fi Direct, Bluetooth, Zigbee, third generation (3G), third generation partnership project (3GPP), and long term evolution (LTE).

The delivery robot 1 may include a pair of driving motors 111. The processor 90 may control the pair of driving motors 111 to move the delivery robot 1 in a desired direction.

The pair of driving motors 111 may be included in the pair of driving wheels 11 described above. When the driving motors 111 operate, the driving wheels 11 rotate, allowing the delivery robot 1 to move.

The delivery robot 1 may include an autonomous driving sensor 99. The processor 90 may use signals input from the autonomous driving sensor 99 to move the delivery robot 1 to its destination. The processor 90 may avoid obstacles in the moving path using the autonomous driving sensor 99. The processor 90 may recognize the state of the moving path using the autonomous driving sensor 99.

The autonomous driving sensor 99 may include an ultrasonic sensor, a three dimensional camera (3D camera), a time of flight sensor (TOF sensor), a light detection and ranging sensor (LiDAR sensor), or the like. The processor 90 may recognize the location of the delivery robot 1 using signals input from the autonomous driving sensor 99. The processor 90 may recognize obstacles on the moving path using signals input from the autonomous driving sensor 99.

The delivery robot 1 may include a microphone 96. The processor 90 may control the delivery robot 1 using a signal input from the microphone 96. The microphone 96 may be configured to convert a user's voice into an electric signal. Therefore, the user may control the delivery robot 1 using voice.

The delivery robot 1 may include a speaker 97. The processor 90 may output an alarm or information regarding the status of the delivery robot 1 as a sound through the speaker 97. The processor 90 may notify the unlocked drawer through the speaker 97.

The delivery robot 1 may include a drawer light 95. The drawer light 95 may include a plurality of drawer lights 95 corresponding to the plurality of drawers 30. The plurality of drawer lights 95 may disposed on the fronts of the plurality of drawers 30, respectively. The processor 90 may turn on/off each of the plurality of drawer lights 95. For example, the processor 90 may turn on the drawer light 95 of the unlocked drawer 30 and turn off the drawer lights 95 of the remaining drawers 30 that may not be opened.

Accordingly, the processor 90 may use the speaker 97 and the drawer lights 95 to inform the customer of the drawer 30 containing the requested object.

The delivery robot 1 may include a power supply 98. The power supply 98 may be configured to supply power to all internal components of the delivery robot 1. For example, a rechargeable battery may be used as the power supply 98.

The processor 90 may recognize the status of the power supply 98 using a signal input from the power supply 98. The processor 90 may output the status of the power supply 98 through the speaker 97. When the power of the power supply 98 is insufficient, the processor 90 may control the pair of driving motors 111 to move the delivery robot 1 to a charging station.

The delivery robot 1 may include a drawer sensor 94. The drawer sensor 94 may be configured to detect whether the drawer 30 is opened or closed. The drawer sensor 94 may include a plurality of drawer sensors 94 corresponding to the plurality of drawers 30. The processor 90 may use signals transmitted from the plurality of drawer sensors 94 to recognize which drawer 30 among the plurality of drawers 30 is open or closed.

The delivery robot 1 may include a motor 73. The motor 73 may be included in the drawer locking device 40. The processor 90 may control the drawer locking device 40 using the motor 73, thereby allowing a specific drawer among the plurality of drawers 30 to be opened, i.e., in an unlocked state. The drawer locking device 40 will be described later.

FIG. 3 is a view illustrating a delivery system of a delivery robot 1 according to one or more embodiments of the disclosure.

Referring to FIG. 3, a delivery system according to one or more embodiments of the disclosure may include the delivery robot 1, the server 100, and a plurality of customer devices, such as customer device A and customer device B, herein customer devices 101 and 102.

The delivery robot 1 may include a plurality of drawers 30 and may be configured to be capable of autonomous navigation. Because the delivery robot 1 has been described above, a detailed description thereof is omitted.

The server 100 may wirelessly communicate with the delivery robot 1 and transmit information to the delivery robot 1. The server 100 may transmit location information of a plurality of customers to the delivery robot 1. The server 100 may be controlled by a supplier who supplies objects.

The server 100 may transmit a plurality of open codes that can open the plurality of drawers 30 to the plurality of customer devices 101 and 102. The plurality of open codes transmitted to the plurality of customer devices 101 and 102 may be different from each other. For example, an open code A transmitted to a customer device A (customer device 101) may be different from an open code B transmitted to a customer device B (customer device 102).

Here, the customer devices 101 and 102 may refer to mobile devices, such as smartphones, or tablet computers, possessed by the customer.

The supplier may load a plurality of objects requested by a plurality of customers into the plurality of drawers 30 of the delivery robot 1, and transmit a plurality of open codes to the plurality of customers via the server 100. The open code may refer to a number, letter, special symbol, or combination thereof that allows a specific customer to open a specific drawer containing the object requested by the specific customer.

For example, when an object A requested by a customer A is loaded in a first drawer 31 (see FIG. 1) and an object B requested by a customer B is loaded in a second drawer 32 (see FIG. 2), the supplier may transmit an open code A for opening the first drawer 31 to the customer device A (customer device 101) of the customer A, and transmit an open code B for opening the second drawer 32 to the customer device B (customer device 102) of the customer B. In addition, the supplier may transmit location information A about the location where the customer A is located and location information B about the location where the customer B is located to the delivery robot 1 via the server 100.

Although FIG. 3 illustrates two customer devices 101 and 102, the disclosure is not limited thereto. The number of customer devices 101 and 102 may be equal to the number of drawers 30 of the delivery robot 1. For example, when the delivery robot 1 includes six drawers 30, the number of customer devices 101 and 102 may be at most six.

Hereinafter, with reference to FIGS. 4, 5, and 6, the drawer locking device 40 of the delivery robot 1 according to one or more embodiments of the disclosure will be described in detail.

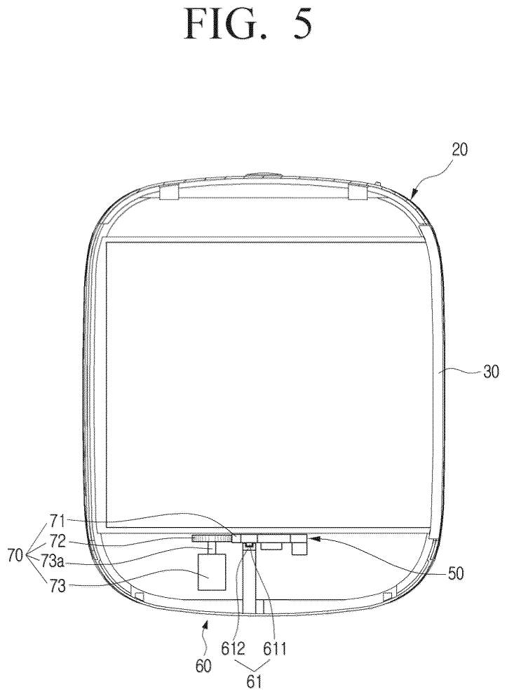

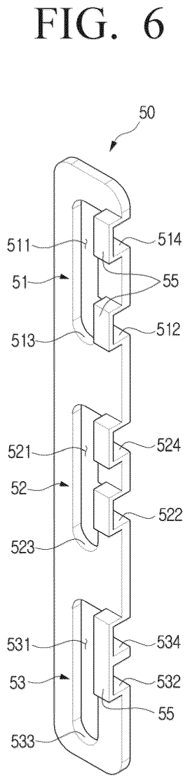

FIG. 4 is a cross-sectional view illustrating the delivery robot 1 of FIG. 1 taken along line A-A. FIG. 5 is a cross-sectional view illustrating the delivery robot 1 of FIG. 1 taken along line B-B. FIG. 6 is a perspective view illustrating a locking plate 50 of a drawer locking device 40 of a delivery robot 1 according to one or more embodiments of the disclosure.

Referring to FIGS. 4 and 5, the drawer locking device 40 according to one or more embodiments of the disclosure may include a plurality of locking protrusions, such as first locking protrusion 311, second locking protrusion 321, and third locking protrusion 331, a locking plate 50, and a moving part 60. The plurality of locking protrusions may each be of a same size.

The plurality of locking protrusions, such as first locking protrusion 311, second locking protrusion 321, and third locking protrusion 331, may be provided on one side surfaces of the plurality of drawers, such as first drawer 31, second drawer 32, and third drawer 33. The plurality of locking protrusions, such as first locking protrusion 311, second locking protrusion 321, and third locking protrusion 331, may be provided in a one-to-one correspondence to the plurality of drawers, such as first drawer 31, second drawer 32, and third drawer 33. In other words, one locking protrusion may be provided on one side surface of each drawer.

The plurality of locking protrusions, such as first locking protrusion 311, second locking protrusion 321, and third locking protrusion 331, may be formed to be positioned on the same vertical line on one side surfaces of the plurality of drawers, such as first drawer 31, second drawer 32, and third drawer 33, (which may be stacked drawers). In detail, when the plurality of drawers, such as first drawer 31, second drawer 32, and third drawer 33, of the delivery robot 1 are closed, the plurality of locking protrusions, such as first locking protrusion 311, second locking protrusion 321, and third locking protrusion 331, may be positioned on a straight line perpendicular to the ground.

Each of the plurality of locking protrusions, such as first locking protrusion 311, second locking protrusion 321, and third locking protrusion 331, may be formed as a protrusion having a circular cross-section.

The locking plate 50 (e.g., FIGS. 4 and 6) may be configured to selectively lock or unlock the plurality of locking protrusions, such as first locking protrusion 311, second locking protrusion 321, and third locking protrusion 331. The locking plate 50 may be disposed inside the upper body 20. The locking plate 50 may be disposed to face one side surfaces of the plurality of drawers, such as first drawer 31, second drawer 32, and third drawer 33. In other words, the locking plate 50 may be disposed to face the plurality of locking protrusions, such as first locking protrusion 311, second locking protrusion 321, and third locking protrusion 331, provided on one side surfaces of the plurality of drawers, such as first drawer 31, second drawer 32, and third drawer 33.

The locking plate 50 may be disposed on the inner surface of the upper body 20 so as to move up and down linearly. Therefore, the locking plate 50 may be raised and lowered within a certain range relative to the plurality of drawers, such as first drawer 31, second drawer 32, and third drawer 33.

The locking plate 50 may be formed in a rectangular flat plate shape that is narrow in width and long in length.

The locking plate 50 may include a plurality of locking portions, such as first locking portion 51, second locking portion 52, and third locking portion 53, that selectively lock or unlock the plurality of locking protrusions, such as first locking protrusion 311, second locking protrusion 321, and third locking protrusion 331.

The plurality of locking portions, such as first locking portion 51, second locking portion 52, and third locking portion 53, may include moving holes, such as first moving hole 511, second moving hole 521, and third moving hole 531, and selection openings, such as first selection opening 512, second selection opening 522, and third selection opening 532, respectively.

The moving holes, such as first moving hole 511, second moving hole 521, and third moving hole 531, may accommodate the locking protrusions, such as first locking protrusion 311, second locking protrusion 321, and third locking protrusion 331, and may be formed as long elongated holes. The moving holes, such as first moving hole 511, second moving hole 521, and third moving hole 531, may be formed to be elongated in the longitudinal direction of the locking plate 50. The locking protrusions, such as first locking protrusion 311, second locking protrusion 321, and third locking protrusion 331, may slide along the moving holes, such as first moving hole 511, second moving hole 521, and third moving hole 531, respectively. In other words, the moving holes, such as first moving hole 511, second moving hole 521, and third moving hole 531, may move vertically with respect to the locking protrusions, such as first locking protrusion 311, second locking protrusion 321, and third locking protrusion 331. Therefore, the locking plate 50 may slide up and down with respect to the locking protrusions, such as first locking protrusion 311, second locking protrusion 321, and third locking protrusion 331.

The selection openings, such as first selection opening 512, second selection opening 522, and third selection opening 532, may be formed in the moving holes, such as first moving hole 511, second moving hole 521, and third moving hole 531. The selection openings, such as first selection opening 512, second selection opening 522, and third selection opening 532, may be formed one side surfaces of the moving holes, such as first moving hole 511, second moving hole 521, and third moving hole 531. The selection openings, such as first selection opening 512, second selection opening 522, and third selection opening 532, may be formed so that the locking protrusions, such as first locking protrusion 311, second locking protrusion 321, and third locking protrusion 331, pass through the selection openings, such as first selection opening 512, second selection opening 522, and third selection opening 532, respectively. In other words, the width of each of the selection openings, such as first selection opening 512, second selection opening 522, and third selection opening 532, may be set to be larger than the diameter of each of the locking protrusions, such as first locking protrusion 311, second locking protrusion 321, and third locking protrusion 331. Therefore, the locking protrusions, such as first locking protrusion 311, second locking protrusion 321, and third locking protrusion 331, may be removed from the moving holes, such as first moving hole 511, second moving hole 521, and third moving hole 531, through the selection openings, such as first selection opening 512, second selection opening 522, and third selection opening 532, respectively.

A reinforcing portion 55 may be provided on one side of each of the selection openings, such as first selection opening 512, second selection opening 522, and third selection opening 532. The reinforcing portion 55 may be provided to block each of the selection openings, such as first selection opening 512, second selection opening 522, and third selection opening 532, from widening. The reinforcing portion 55 may be provided on one side surface of the locking plate 50 that does not face the drawers 30. The reinforcing portion 55 may be formed to connect both ends of each of the selection openings, such as first selection opening 512, second selection opening 522, and third selection opening 532. For example, the reinforcing portion 55 may be formed in a substantially U-shape with a flat bottom.

The plurality of locking portions, such as first locking portion 51, second locking portion 52, and third locking portion 53, may be configured so that the distances from the bottoms of the moving holes, such as first moving hole 511, second moving hole 521, and third moving hole 531, to the selection openings, such as first selection opening 512, second selection opening 522, and third selection opening 532, are different from each other.

Referring to FIG. 4, the drawer locking device 40 according to one or more embodiments of the disclosure may include three locking protrusions, such as first locking protrusion 311, second locking protrusion 321, and third locking protrusion 331, provided on three drawers, such as first drawer 31, second drawer 32, and third drawer 33, and a locking plate 50 including three locking portions, such as first locking portion 51, second locking portion 52, and third locking portion 53.

A first locking protrusion 311 may be disposed on the side surface of the first drawer 31, a second locking protrusion 321 may be disposed on the side surface of the second drawer 32, and a third locking protrusion 331 may be disposed on the side surface of the third drawer 33. In other words, the first locking protrusion 311 may be disposed on the side surface of the uppermost drawer 31, the third locking protrusion 331 may be disposed on the side surface of the lowermost drawer 33, and the second locking protrusion 321 may be disposed on the side surface of the intermediate drawer 32.

The locking plate 50 may include three locking portions: a first locking portion 51, a second locking portion 52, and a third locking portion 53. The first locking portion 51 may be configured to selectively unlock the first locking protrusion 311, the second locking portion 52 may be configured to selectively unlock the second locking protrusion 321, and the third locking portion 53 may be configured to selectively unlock the third locking protrusion 331.

The first locking portion 51 may include a first moving hole 511 and a first selection opening 512. The distance from the bottom of the first moving hole 511 to the bottom of the first selection opening 512 may be a first distance d1. The second locking portion 52 may include a second moving hole 521 and a second selection opening 522. The distance from the bottom of the second moving hole 521 to the bottom of the second selection opening 522 may be a second distance d2. The third locking portion 53 may include a third moving hole 531 and a third selection opening 532. The distance from the bottom of the third moving hole 531 to the bottom of the third selection opening 532 may be a third distance d3.

In this case, plurality of moving holes, such as first moving hole 511, second moving hole 521, and third moving hole 531, may be configured such that the distances from the bottoms of the plurality of moving holes, such as first moving hole 511, second moving hole 521, and third moving hole 531, to the bottoms of the plurality of selection openings, such as first selection opening 512, second selection opening 522, and third selection opening 532, are different from each other. In other words, the first distance d1, the second distance d2, and the third distance d3 may be formed to be different from each other.

In addition, the distances from the bottoms of the moving holes, such as first moving hole 511, second moving hole 521, and third moving hole 531, to the selection openings, such as first selection opening 512, second selection opening 522, and third selection opening 532, of the plurality of locking portions, such as first locking portion 51, second locking portion 52, and third locking portion 53, may be defined so that the distance from the bottom of the moving hole 531 to the selection opening 532 of the lowermost locking portion 53 located at the bottom among the plurality of locking portions, such as first locking portion 51, second locking portion 52, and third locking portion 53, is longest, and the distance from the bottom of the moving hole 511 to the selection opening 512 of the uppermost locking portion 51 located at the top among the plurality of locking portions, such as first locking portion 51, second locking portion 52, and third locking portion 53, is the shortest.

In FIG. 4, the first locking portion 51 may be the uppermost locking portion located at the top among the plurality of locking portions, such as first locking portion 51, second locking portion 52, and third locking portion 53, and the third locking portion 53 may be the lowermost locking portion 53 located at the bottom among the plurality of locking portions, such as first locking portion 51, second locking portion 52, and third locking portion 53. The second locking portion 52 may be the intermediate locking portion located between the uppermost locking portion and the lowermost locking portion. Accordingly, the three selection openings, such as first selection opening 512, second selection opening 522, and third selection opening 532, of the three locking portions, such as first locking portion 51, second locking portion 52, and third locking portion 53, may be formed so that the first distance d1<the second distance d2<the third distance d3.

In this way, by making the distances of the plurality of selection openings, such as first selection opening 512, second selection opening 522, and third selection opening 532, of the plurality of locking portions, such as first locking portion 51, second locking portion 52, and third locking portion 53, formed on the locking plate 50 different, only one of the plurality of drawers, such as first drawer 31, second drawer 32, and third drawer 33, may be opened.

In addition, the locking plate 50 may be configured so that none of the plurality of drawers, such as first drawer 31, second drawer 32, and third drawer 33, is opened. To this end, the locking plate 50 may include a plurality of blocking grooves, such as first blocking groove 513, second blocking groove 523, and third blocking groove 533. The plurality of blocking grooves, such as first blocking groove 513, second blocking groove 523, and third blocking groove 533, may be provided in the plurality of locking portions, such as first locking portion 51, second locking portion 52, and third locking portion 53, respectively. The plurality of blocking grooves, such as first blocking groove 513, second blocking groove 523, and third blocking groove 533, may be provided at the bottoms of the plurality of moving holes, such as first moving hole 511, second moving hole 521, and third moving hole 531, respectively.

The plurality of blocking grooves, such as first blocking groove 513, second blocking groove 523, and third blocking groove 533, may be configured to block the movement of the plurality of locking protrusions, such as first locking protrusion 311, second locking protrusion 321, and third locking protrusion 331, respectively. In other words, the plurality of blocking grooves, such as first blocking groove 513, second blocking groove 523, and third blocking groove 533, may be configured to block the plurality of locking protrusions, such as first locking protrusion 311, second locking protrusion 321, and third locking protrusion 331, from moving in a direction perpendicular to the moving holes, such as first moving hole 511, second moving hole 521, and third moving hole 531, respectively. Therefore, when the locking protrusions, such as first locking protrusion 311, second locking protrusion 321, and third locking protrusion 331, are positioned in the blocking grooves, such as first blocking groove 513, second blocking groove 523, and third blocking groove 533, the locking protrusions, such as first locking protrusion 311, second locking protrusion 321, and third locking protrusion 331, may not fall out of the moving holes, such as first moving hole 511, second moving hole 521, and third moving hole 531, respectively. Accordingly, when the locking protrusions, such as first locking protrusion 311, second locking protrusion 321, and third locking protrusion 331, are positioned in the blocking grooves, such as first blocking groove 513, second blocking groove 523, and third blocking groove 533, the drawers 30 provided with the locking protrusions, such as first locking protrusion 311, second locking protrusion 321, and third locking protrusion 331, may not be removed.

The plurality of blocking grooves, such as first blocking groove 513, second blocking groove 523, and third blocking groove 533, may be configured at the same intervals as the intervals of the plurality of locking protrusions, such as first locking protrusion 311, second locking protrusion 321, and third locking protrusion 331. Accordingly, the plurality of locking protrusions, such as first locking protrusion 311, second locking protrusion 321, and third locking protrusion 331, may be positioned in the plurality of blocking grooves, such as first blocking groove 513, second blocking groove 523, and third blocking groove 533, at the same time.

For example, as illustrated in FIG. 4, the first locking portion 51 may include a first blocking groove 513 provided at the bottom of the first moving hole 511, the second locking portion 52 may include a second blocking groove 523 provided at the bottom of the second moving hole 521, and the third locking portion 53 may include a third blocking groove 533 provided at the bottom of the third moving hole 531.

When the first locking protrusion 311 is positioned in the first blocking groove 513, the second locking protrusion 321 and the third locking protrusion 331 may be positioned in the second blocking groove 523 and the third blocking groove 533, respectively.

Accordingly, when the plurality of locking protrusions, such as first locking protrusion 311, second locking protrusion 321, and third locking protrusion 331, are respectively positioned in the blocking grooves, such as first blocking groove 513, second blocking groove 523, and third blocking groove 533, of the moving holes, such as first moving hole 511, second moving hole 521, and third moving hole 531, of the plurality of locking portions, such as first locking portion 51, second locking portion 52, and third locking portion 53, none of the plurality of drawers, such as first drawer 31, second drawer 32, and third drawer 33, may be opened.

In addition, the locking plate 50 may be configured so that all of the plurality of drawers, such as first drawer 31, second drawer 32, and third drawer 33, are opened. To this end, the locking plate 50 may include a plurality of overall openings, such as first overall opening 514, second overall opening 524, and third overall opening 534. The plurality of overall openings, such as first overall opening 514, second overall opening 524, and third overall opening 534, may be provided in the plurality of locking portions, such as first locking portion 51, second locking portion 52, and third locking portion 53, respectively. The plurality of overall openings, such as first overall opening 514, second overall opening 524, and third overall opening 534, may be provided at the upper ends of the plurality of moving holes, such as first moving hole 511, second moving hole 521, and third moving hole 531, respectively. In other words, the plurality of overall openings, such as first overall opening 514, second overall opening 524, and third overall opening 534, may be formed on one sides of the moving holes, such as first moving hole 511, second moving hole 521, and third moving hole 531, so as to be in contact with the upper ends of the plurality of moving holes, such as first moving hole 511, second moving hole 521, and third moving hole 531, respectively.

The plurality of overall openings, such as first overall opening 514, second overall opening 524, and third overall opening 534, may be configured so that the plurality of locking protrusions, such as first locking protrusion 311, second locking protrusion 321, and third locking protrusion 331, pass through the plurality of overall openings, such as first overall opening 514, second overall opening 524, and third overall opening 534, respectively. In other words, the widths of the plurality of overall openings, such as first overall opening 514, second overall opening 524, and third overall opening 534, may be set to be larger than the diameters of the plurality of locking protrusions, such as first locking protrusion 311, second locking protrusion 321, and third locking protrusion 331, respectively. The overall openings, such as first overall opening 514, second overall opening 524, and third overall opening 534, may be formed to have the same width as the selection openings, such as first selection opening 512, second selection opening 522, and third selection opening 532, respectively. Therefore, the locking protrusions, such as first locking protrusion 311, second locking protrusion 321, and third locking protrusion 331, may be removed from the moving holes, such as first moving hole 511, second moving hole 521, and third moving hole 531, through the overall openings, such as first overall opening 514, second overall opening 524, and third overall opening 534, respectively. Accordingly, when the locking protrusions, such as first locking protrusion 311, second locking protrusion 321, and third locking protrusion 331, are positioned in the overall openings, such as first overall opening 514, second overall opening 524, and third overall opening 534, the customer may remove the drawer 30 from the delivery robot 1.

The plurality of overall openings, such as first overall opening 514, second overall opening 524, and third overall opening 534, may be configured at intervals equal to the intervals between the plurality of locking protrusions, such as first locking protrusion 311, second locking protrusion 321, and third locking protrusion 331. Accordingly, the plurality of locking protrusions, such as first locking protrusion 311, second locking protrusion 321, and third locking protrusion 331, may be simultaneously positioned in the plurality of overall openings, such as first overall opening 514, second overall opening 524, and third overall opening 534, respectively.

For example, as illustrated in FIG. 4, the first locking portion 51 may include a first overall opening 514 provided one side of the upper end of the first moving hole 511, the second locking portion 52 may include a second overall opening 524 provided one side of the upper end of the second moving hole 521, and the third locking portion 53 may include a third overall opening 534 provided one side of the upper end of the third moving hole 531.

The distances d from the bottoms of the plurality of moving holes, such as first moving hole 511, second moving hole 521, and third moving hole 531, to the plurality of overall openings, such as first overall opening 514, second overall opening 524, and third overall opening 534, may be formed to be the same. For example, the distance d from the bottom of the first moving hole 511 to the bottom of the first overall opening 514, the distance d from the bottom of the second moving hole 521 to the bottom of the second overall opening 524, and the distance d from the bottom of the third moving hole 531 to the bottom of the third overall opening 534 may be all the same.

When the first locking protrusion 311 is positioned in the first overall opening 514, the second locking protrusion 321 and the third locking protrusion 331 may also be positioned in the second overall opening 524 and the third overall opening 534, respectively.

Therefore, when the plurality of locking protrusions, such as first locking protrusion 311, second locking protrusion 321, and third locking protrusion 331, are respectively positioned in the overall openings, such as first overall opening 514, second overall opening 524, and third overall opening 534, of the moving holes, such as first moving hole 511, second moving hole 521, and third moving hole 531, of the plurality of locking portions, such as first locking portion 51, second locking portion 52, and third locking portion 53, all of the plurality of drawers, such as first drawer 31, second drawer 32, and third drawer 33, may be opened.

A reinforcing portion 55 may be provided on one side of each of the overall openings, such as first overall opening 514, second overall opening 524, and third overall opening 534. The reinforcing portions 55 may be provided to block the overall openings, such as first overall opening 514, second overall opening 524, and third overall opening 534, from widening, respectively. The reinforcing portion 55 may be provided on one side surface of the locking plate 50 that does not face the drawers 30. The reinforcing portion 55 may be formed to connect both ends of each of the overall openings, such as first overall opening 514, second overall opening 524, and third overall opening 534. For example, the reinforcing portion 55 may be formed in a substantially U-shape with a flat bottom. The reinforcing portions 55 provided in the overall openings, such as first overall opening 514, second overall opening 524, and third overall opening 534, may be formed in the same manner as the reinforcing portions 55 provided in the selection openings, such as first selection opening 512, second selection opening 522, and third selection opening 532.

The moving part 60 may be configured to vertically move the locking plate 50 relative to the plurality of drawers, such as first drawer 31, second drawer 32, and third drawer 33. Therefore, the locking plate 50 may move up and down in a straight line by the moving part 60.

The moving part 60 may include a guide member 61 and a driving unit 70.

The guide member 61 may be configured to guide the linear movement of the locking plate 50. The guide member 61 may be configured as a rail structure.

Referring to FIGS. 4 and 5, the guide member 61 may include a moving rail 611 disposed on the locking plate 50 and a guide rail 612 disposed in the upper body 20.

The moving rail 611 may be disposed in the longitudinal direction on the locking plate 50. In other words, the moving rail 611 may be disposed on the locking plate 50 in parallel with the plurality of moving holes, such as first moving hole 511, second moving hole 521, and third moving hole 531. The moving rail 611 may be spaced apart from the plurality of moving holes, such as first moving hole 511, second moving hole 521, and third moving hole 531, by a certain distance so as not to interfere with the locking protrusions, such as first locking protrusion 311, second locking protrusion 321, and third locking protrusion 331, accommodated in the plurality of moving holes, such as first moving hole 511, second moving hole 521, and third moving hole 531.

The guide rail 612 may be disposed on the inner surface of the upper body 20. The guide rail 612 may be fixed to the inner surface of the upper body 20 where the locking plate 50 is disposed. The guide rail 612 may be configured to accommodate the moving rail 611. The moving rail 611 may slide along the guide rail 612. For example, the guide rail 612 may be formed in a channel shape corresponding to the moving rail 611.

In this embodiment, the guide member 61 is described as having a rail structure, but the guide member 61 is not limited thereto. The guide member 61 may be formed in any structure that can guide the locking plate 50 to move in a straight line. For example, the guide member 61 may be formed as a linear motion guide, a slide shaft, or the like.

The driving unit 70 may be configured to move the locking plate 50 in an up-and-down direction. Accordingly, the locking plate 50 may perform a linear movement within a certain range by the driving unit 70.

The driving unit 70 may include a rack gear 71, a pinion 72, and a motor 73.

The rack gear 71 may be disposed on one side of the locking plate 50. The rack gear 71 may be disposed on the locking plate 50 so as not to interfere with the guide member 61.

The pinion 72 may be disposed to mesh with the rack gear 71. The pinion 72 may be rotated by the motor 73. Therefore, when the pinion 72 rotates in one direction, the rack gear 71 may rise. When the pinion 72 rotates in the opposite direction, the rack gear 71 may descend.

The motor 73 may be configured to generate a driving force that rotates the pinion 72. The motor 73 may include a motor shaft 73a. The motor 73 may be configured to rotate the motor shaft 73a in both directions. The pinion 72 may be fixed to the motor shaft 73a. Therefore, when the motor shaft 73a rotates, the pinion 72 may rotate integrally with the motor shaft 73a.

The motor 73 may be fixed inside the upper body 20. The motor 73 may be disposed so as not to interfere with the locking plate 50 and the plurality of drawers, such as first drawer 31, second drawer 32, and third drawer 33.

When the motor shaft 73a of the motor 73 is rotated, the pinion 72 fixed to the motor shaft 73a rotates. When the pinion 72 rotates, the rack gear 71 meshed with the pinion 72 may move up and down. At this time, because the rack gear 71 is fixed to the locking plate 50, when the rack gear 71 moves up and down, the locking plate 50 may move up and down together with the rack gear 71. When the locking plate 50 moves, the plurality of locking portions, such as first locking portion 51, second locking portion 52, and third locking portion 53, of the locking plate 50 may move relative to the plurality of locking protrusions, such as first locking protrusion 311, second locking protrusion 321, and third locking protrusion 331, provided in the plurality of drawers, such as first drawer 31, second drawer 32, and third drawer 33.

When the selection openings, such as first selection opening 512, second selection opening 522, and third selection opening 532, of the plurality of locking portions, such as first locking portion 51, second locking portion 52, and third locking portion 53, are respectively aligned with the locking protrusions, such as first locking protrusion 311, second locking protrusion 321, and third locking protrusion 331, the locking protrusions, such as first locking protrusion 311, second locking protrusion 321, and third locking protrusion 331, may come out of the moving holes, such as first moving hole 511, second moving hole 521, and third moving hole 531, through the selection openings, such as first selection opening 512, second selection opening 522, and third selection opening 532. Therefore, the drawers 30 provided with locking protrusions, such as first locking protrusion 311, second locking protrusion 321, and third locking protrusion 331, may be removed.

In the above-described embodiment, the driving unit 70 includes the rack gear 71 and the pinion 72, but the disclosure is not limited thereto. The driving unit 70 may be configured in various structures as long as it can move the locking plate 50 in a linear manner.

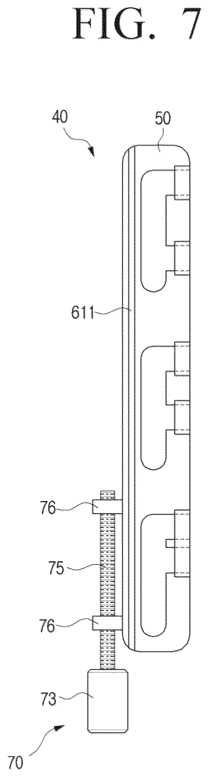

FIG. 7 is a view illustrating a drawer locking device 40 of a delivery robot 1 according to one or more embodiments of the disclosure.

Referring to FIG. 7, the driving unit 70 may include a ball screw 75 and a motor 73.

The ball screw 75 may be disposed on one side of the locking plate 50. The ball screw 75 may be supported by a pair of ball nuts 76 fixed to one side of the locking plate 50.

The motor 73 may be disposed to rotate the ball screw 75. The motor 73 may be disposed at one end of the ball screw 75. One end of the ball screw 75 may be coupled to the motor shaft. Therefore, when the motor 73 rotates, the ball screw 75 may rotate, allowing the locking plate 50 to move in a linear manner.

When the ball screw 75 is rotated in one direction by the motor 73, the locking plate 50 may be raised. When the ball screw 75 is rotated in the opposite direction by the motor 73, the locking plate 50 may be lowered.

In this case, the locking plate 50 may be guided in linear movement by the guide member 61. In other words, the locking plate 50 may be guided in linear movement by the moving rail 611 and the guide rail 612 (see FIG. 5).

Hereinafter, the operation of the delivery robot 1 according to one or more embodiments of the disclosure will be described in detail with reference to the attached FIG. 4 and FIGS. 8A to 11B.

In FIG. 4, the plurality of locking protrusions, such as first locking protrusion 311, second locking protrusion 321, and third locking protrusion 331, are all positioned in the plurality of blocking grooves, such as first blocking groove 513, second blocking groove 523, and third blocking groove 533. In this case, the locking protrusions, such as first locking protrusion 311, second locking protrusion 321, and third locking protrusion 331, may not be removed from the moving holes, such as first moving hole 511, second moving hole 521, and third moving hole 531, in the horizontal direction. Therefore, none of the plurality of drawers, such as first drawer 31, second drawer 32, and third drawer 33, disposed in the upper body 20 of the delivery robot 1 may be opened. In other words, when the user grabs and pulls the handles of the drawers 31, 32, and 33, none of the drawers 31, 32, and 33 may be pulled out of the upper body 20.

In the state of FIG. 4, the processor 90 may operate the drawer locking device 40 to move the locking plate 50 downward a certain distance.

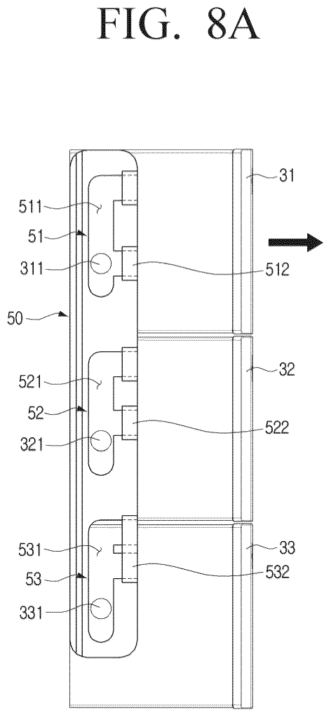

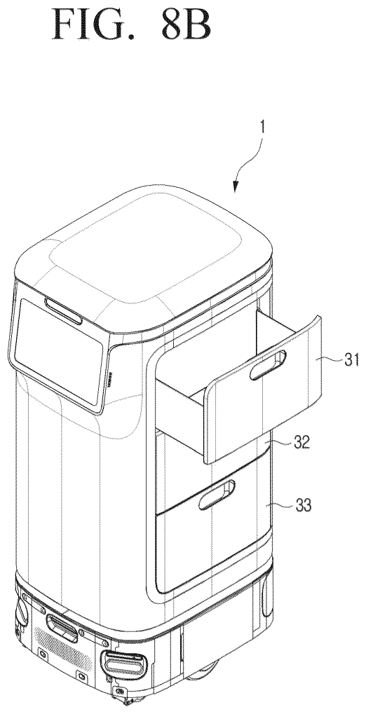

In the state of FIG. 4, when the locking plate 50 moves a first direction d1, the state of FIG. 8A occurs.

FIG. 8A is a view illustrating a relationship between a locking plate 50 and locking protrusions, such as first locking protrusion 311, second locking protrusion 321, and third locking protrusion 331, of a drawer locking device 40 that allows a first drawer 31 of a delivery robot 1 to be opened according to one or more embodiments of the disclosure. FIG. 8B is a perspective view illustrating a state in which the first drawer 31 is opened when the drawer locking device 40 of the delivery robot 1 is in the state of FIG. 8A according to one or more embodiments of the disclosure.

Referring to FIG. 8A, the first selection opening 512 of the locking plate 50 and the first locking protrusion 311 of the first drawer 31 are aligned in a straight line, facing each other. In other words, when the locking plate 50 is lowered downwards by a first distance d1, the center of the first selection opening 512 and the center of the first locking protrusion 311 of the first drawer 31 are positioned on the same horizontal line.

In this state, when the user pulls the first drawer 31 to the right (in the direction of arrow), the first locking protrusion 311 of the first drawer 31 may pass through the first selection opening 512 of the locking plate 50 and move to the right. Therefore, this case may be said to be a state in which the drawer locking device 40 unlocks the first drawer 31.

When the first locking protrusion 311 passes through the first selection opening 512, the first drawer 31 is opened from the upper body 20 of the delivery robot 1, as illustrated in FIG. 8B. Therefore, the user may remove objects from the first drawer 31.

At this time, the second locking protrusion 321 of the second drawer 32 may face the side of the second moving hole 521, and may not be aligned in a straight line with the second selection opening 522. Therefore, when the user pulls the second drawer 32 to the right, the second drawer 32 may not move to the right.

In addition, the third locking protrusion 331 of the third drawer 33 may face the side of the third moving hole 531, and may not be aligned in a straight line with the third selection opening 532. Therefore, when the user pulls the third drawer 33 to the right, the third drawer 33 may not move to the right.

In other words, in the cases of FIGS. 8A and 8B, only the first drawer 31 is unlocked, while the second drawer 32 and third drawer 33 are locked. Therefore, the user may open only the first drawer 31, and may not open the second drawer 32 and the third drawer 33.

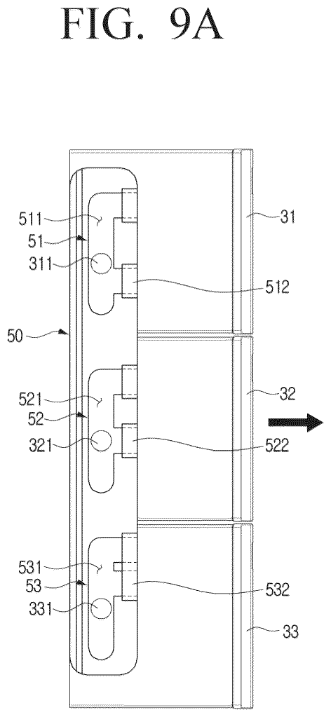

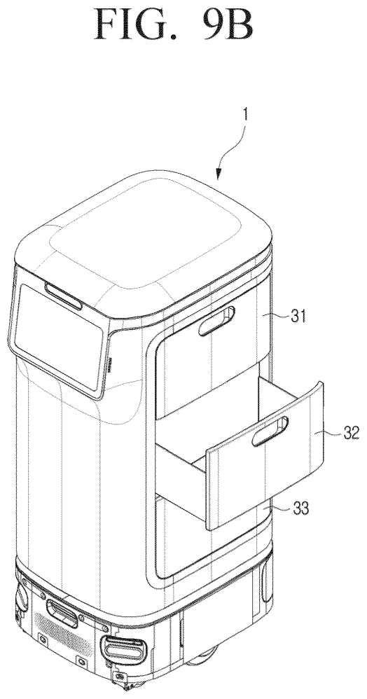

In the state of FIG. 4, when the locking plate 50 moves the second distance d2, the state of FIG. 9A occurs.

FIG. 9A is a view illustrating a relationship between a locking plate 50 and locking protrusions, such as first locking protrusion 311, second locking protrusion 321, and third locking protrusion 331, of a drawer locking device 40 that allows a second drawer 32 of a delivery robot 1 to be opened according to one or more embodiments of the disclosure. FIG. 9B is a perspective view illustrating a state in which the second drawer 32 is opened when the drawer locking device 40 of the delivery robot 1 is in the state of FIG. 9A according to one or more embodiments of the disclosure.

Referring to FIG. 9A, the second selection opening 522 of the locking plate 50 and the second locking protrusion 321 of the second drawer 32 are aligned in a straight line, facing each other. In other words, when the locking plate 50 is lowered downwards by a second distance d2, the center of the second selection opening 522 and the center of the second locking protrusion 321 of the second drawer 32 are positioned on the same horizontal line.

In this state, when the user pulls the second drawer 32 to the right (in the direction of arrow), the second locking protrusion 321 of the second drawer 32 may pass through the second selection opening 522 of the locking plate 50 and move to the right. Therefore, this case may be said to be a state in which the drawer locking device 40 unlocks the second drawer 32.

When the second locking protrusion 321 passes through the second selection opening 522, the second drawer 32 may be opened from the upper body 20 of the delivery robot 1, as illustrated in FIG. 9B. Therefore, the user may remove objects from the second drawer 32.

At this time, the first locking protrusion 311 of the first drawer 31 may face the side of the first moving hole 511, and may not be aligned in a straight line with the first selection opening 512. Therefore, when the user pulls the first drawer 31 to the right, the first drawer 31 may not move to the right.

In addition, the third locking protrusion 331 of the third drawer 33 may face the side of the third moving hole 531, and may not be aligned in a straight line with the third selection opening 532. Therefore, when the user pulls the third drawer 33 to the right, the third drawer 33 may not move to the right.

In other words, in the cases of FIGS. 9A and 9B, only the second drawer 32 is unlocked, while the first drawer 31 and third drawer 33 are locked. Therefore, the user may open only the second drawer 32, and may not open the first drawer 31 and the third drawer 33.

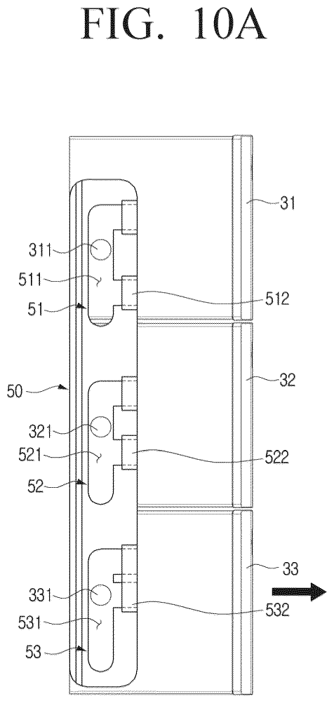

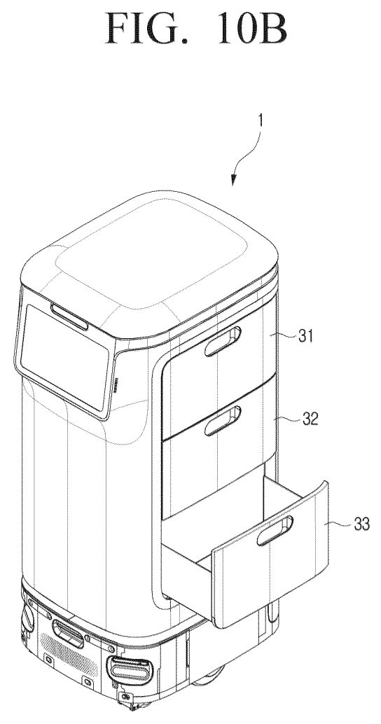

In the state of FIG. 4, when the locking plate 50 moves the third distance d3, the state of FIG. 10A occurs.

FIG. 10A is a view illustrating a relationship between a locking plate 50 and locking protrusions, such as first locking protrusion 311, second locking protrusion 321, and third locking protrusion 331, of a drawer locking device 40 that allows a third drawer 33 of a delivery robot 1 according to one or more embodiments of the disclosure to be opened. FIG. 10B is a perspective view illustrating a state in which the third drawer 33 is opened when the drawer locking device 40 of the delivery robot 1 according to one or more embodiments of the disclosure is in the state of FIG. 10A.

Referring to FIG. 10A, the third selection opening 532 of the locking plate 50 and the third locking protrusion 331 of the third drawer 33 are aligned in a straight line, facing each other. In other words, when the locking plate 50 is lowered downwards by a third distance d3, the center of the third selection opening 532 and the center of the third locking protrusion 331 of the third drawer 33 are positioned on the same horizontal line.

In this state, when the user pulls the third drawer 33 to the right (in the direction of arrow), the third locking protrusion 331 of the third drawer 33 may pass through the third selection opening 532 of the locking plate 50 and move to the right. Therefore, this case may be said to be a state in which the drawer locking device 40 unlocks the third drawer 33.

When the third locking protrusion 331 passes through the third selection opening 532, the third drawer 33 may be opened from the upper body 20 of the delivery robot 1, as illustrated in FIG. 10B. Therefore, the user may take out objects in the third drawer 33.

At this time, the first locking protrusion 311 of the first drawer 31 may face the side of the first moving hole 511, and may not be aligned in a straight line with the first selection opening 512. Therefore, when the user pulls the first drawer 31 to the right, the first drawer 31 may not move to the right.

In addition, the second locking protrusion 321 of the second drawer 32 may face the side of the second moving hole 521, and may not be aligned in a straight line with the second selection opening 522. Therefore, when the user pulls the second drawer 32 to the right, the second drawer 32 may not move to the right.

In other words, in the cases of FIGS. 10A and 10B, only the third drawer 33 is unlocked, while the first drawer 31 and second drawer 32 are locked. Therefore, the user may open only the third drawer 33, and may not open the first drawer 31 and the second drawer 32.

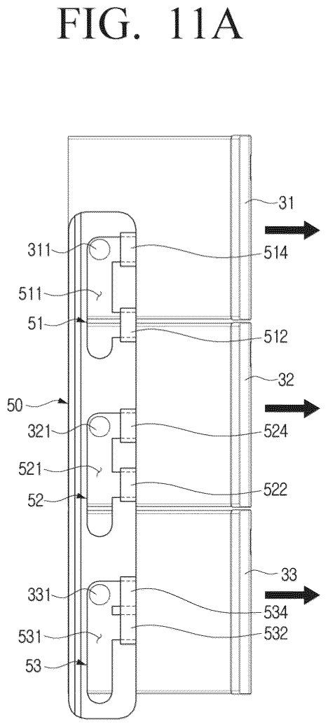

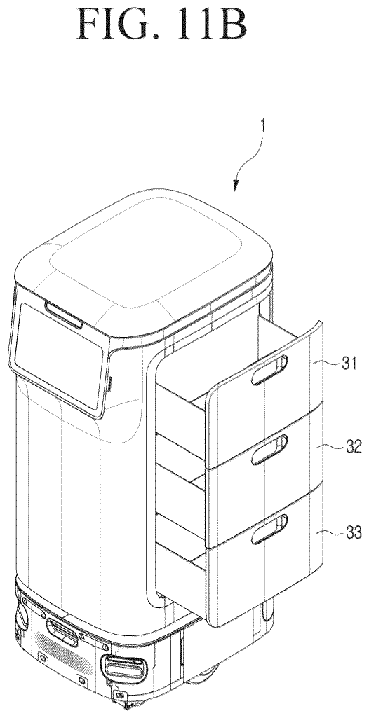

In the state of FIG. 4, when the locking plate 50 moves the maximum distance, i.e., a fourth distance (the distance d, for example), the state of FIG. 11A occurs.

FIG. 11A is a view illustrating a relationship between a locking plate 50 and locking protrusions, such as first locking protrusion 311, second locking protrusion 321, and third locking protrusion 331, of a drawer locking device 40 that allows all drawers of a delivery robot 1 to be opened according to one or more embodiments of the disclosure. FIG. 11B is a perspective view illustrating a state in which all drawers are opened when the drawer locking device 40 of the delivery robot 1 is in the state of FIG. 11A according to one or more embodiments of the disclosure.

Referring to FIG. 11A, the first overall opening 514 of the locking plate 50 is aligned in a straight line with the first locking protrusion 311 of the first drawer 31, the second overall opening 524 of the locking plate 50 is aligned in a straight line with the second locking protrusion 321 of the second drawer 32, and the third overall opening 534 of the locking plate 50 is aligned in a straight line with the third locking protrusion 331 of the third drawer 33.

In other words, when the locking plate 50 is lowered downward by the maximum distance d, the center of the first overall opening 514 and the center of the first locking protrusion 311 of the first drawer 31 are positioned on the same horizontal line, the center of the second overall opening 524 and the center of the second locking protrusion 321 of the second drawer 32 are positioned on the same horizontal line, and the center of the third overall opening 534 and the center of the third locking protrusion 331 of the third drawer 33 are positioned on the same horizontal line.

In this state, when the user pulls the first drawer 31 to the right (in the direction of arrow), the first locking protrusion 311 of the first drawer 31 may pass through the first overall opening 514 of the locking plate 50 and move to the right.

In addition, when the user pulls the second drawer 32 to the right (in the direction of arrow), the second locking protrusion 321 of the second drawer 32 may pass through the second overall opening 524 of the locking plate 50 and move to the right.

Similarly, when the user pulls the third drawer 33 to the right (in the direction of arrow), the third locking protrusion 331 of the third drawer 33 may pass through the third overall opening 534 of the locking plate 50 and move to the right.

Accordingly, as illustrated in FIG. 11B, the first drawer 31, the second drawer 32, and the third drawer 33 may all be opened from the upper body 20 of the delivery robot 1. Therefore, the user may take out objects from the first drawer 31, the second drawer 32, and the third drawer 33.

In other words, in the cases of FIGS. 11A and 11B, all drawers, i.e., the first drawer 31, the second drawer 32, and third drawer 33, are unlocked, and no drawers are locked. Therefore, the user may open all the drawers.

When the locking plate 50 is raised to its maximum in the state of FIG. 11A, i.e., raised by the fourth distance d, as illustrated in FIG. 4, the plurality of locking protrusions, such as first locking protrusion 311, second locking protrusion 321, and third locking protrusion 331, may be all positioned in the plurality of blocking grooves, such as first blocking groove 513, second blocking groove 523, and third blocking groove 533, respectively. Therefore, because the plurality of drawers, such as first drawer 31, second drawer 32, and third drawer 33, are all locked, the user may not open any of the drawers.

The above description has been given of a case where the delivery robot 1 includes the plurality of drawers, such as first drawer 31, second drawer 32, and third drawer 33, provided on one side thereof. However, as another example, the delivery robot 1 may include a plurality of drawers, such as first drawer 31, second drawer 32, and third drawer 33, provided on both sides thereof.

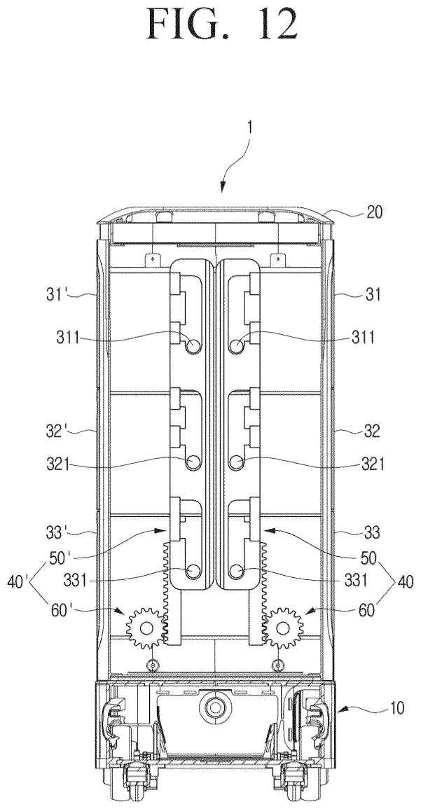

FIG. 12 is a view illustrating a delivery robot 1 according to one or more embodiments of the disclosure including a plurality of drawers, such as first drawer 31, second drawer 32, and third drawer 33, and a plurality of additional drawers 31′, 32′, and 33′.

Referring to FIG. 12, a delivery robot 1 according to one or more embodiments of the disclosure may include a moving body 10 and an upper body 20.

The moving body 10 may be identical to that of the above-described embodiment, and thus a detailed description thereof is omitted.

The upper body 20 may be disposed on the upper surface of the moving body 10. The upper body 20 may be configured to accommodate a plurality of objects to be delivered to a plurality of customers. For example, the upper body 20 may include a plurality of drawers, such as first drawer 31, second drawer 32, and third drawer 33, and a plurality of additional drawers 31′, 32′, and 33′ for accommodating the plurality of objects.

The plurality of drawers, such as first drawer 31, second drawer 32, and third drawer 33, may be detachably disposed on one side of the upper body 20. The plurality of additional drawers 31′, 32′, and 33′ may be detachably disposed on the opposite side from the plurality of drawers, such as first drawer 31, second drawer 32, and third drawer 33.

The drawers, such as first drawer 31, second drawer 32, and third drawer 33, may be configured to accommodate objects. For example, the drawers, such as first drawer 31, second drawer 32, and third drawer 33, may be configured in a container shape with a rectangular bottom. A handle may be provided on the front of each of the drawers, such as first drawer 31, second drawer 32, and third drawer 33. The user may open and close the drawers, such as first drawer 31, second drawer 32, and third drawer 33, using the handle. The additional drawers 31′, 32′, and 33′ may be configured in the same manner as the drawers, such as first drawer 31, second drawer 32, and third drawer 33.

The upper body 20 may include a drawer locking device 40 that selectively unlocks the plurality of drawers, such as first drawer 31, second drawer 32, and third drawer 33. For example, the drawer locking device 40 may be configured to unlock a selected drawer among the plurality of drawers, such as first drawer 31, second drawer 32, and third drawer 33, and lock the remaining drawers.

The drawer locking device 40 may be the same as the drawer locking device 40 of the delivery robot 1 according to the above-described embodiment, so a detailed description thereof is omitted.

In addition, the upper body 20 may include an additional drawer locking device 40′ capable of selectively unlocking the plurality of additional drawers 31′, 32′, and 33′. For example, the additional drawer locking device 40′ may be configured to unlock a selected one of the plurality of additional drawers 31′, 32′, and 33′ and lock the remaining additional drawers.

The additional drawer locking device 40′ may be configured in the same manner as the drawer locking device 40. However, because the plurality of drawers, such as first drawer 31, second drawer 32, and third drawer 33, and the additional drawers 31′, 32′, and 33′ are disposed oppositely, the additional drawer locking device 40′ may be configured to be symmetrically with the drawer locking device 40.

The additional drawer locking device 40′ may include a plurality of locking protrusions, such as first locking protrusion 311, second locking protrusion 321, and third locking protrusion 331, a locking plate 50′, and a moving part 60′. The plurality of locking protrusions, such as first locking protrusion 311, second locking protrusion 321, and third locking protrusion 331, the locking plate 50′, and the moving part 60′ may be configured in the same structure as them of the above-described drawer locking device 40, and therefore detailed descriptions thereof are omitted.

Therefore, the additional drawer locking device 40′ may unlock one additional drawer selected from among the plurality of additional drawers 31′, 32′, and 33′ and lock the remaining additional drawers. For example, the additional drawer locking device 40′ may unlock the first additional drawers 31′ and lock the second and third additional drawers 32′ and 33′.

The upper body 20 may include a user interface 92. The user interface 92 may be disposed on the upper portion of the front of the upper body 20. The user interface 92 may be configured as a touch display. Accordingly, the user may input an open code into the delivery robot 1 using the touch display.

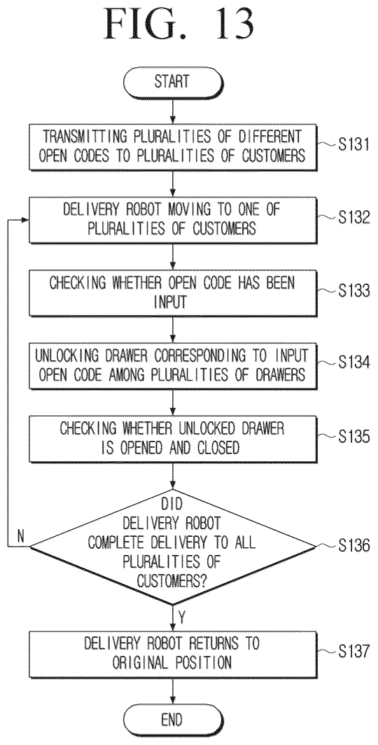

Hereinafter, a delivery method using a delivery robot 1 according to one or more embodiments of the disclosure will be described in detail with reference to FIG. 13.

FIG. 13 is a flowchart illustrating a delivery method using a delivery robot 1 according to one or more embodiments of the disclosure.

Referring to FIG. 13, a delivery method using a delivery robot 1 according to one or more embodiments of the disclosure may include a) transmitting a plurality of different open codes to a plurality of customers, b) moving, a delivery robot 1 including a plurality of drawers, to one of the plurality of customers, c) checking, the delivery robot 1, whether an open code has been input, d) operating, the delivery robot 1, a drawer locking device 40 to unlock a drawer corresponding to the input open code among the plurality of drawers based on of the open code being input, e) checking, the delivery robot 1, whether the unlocked drawer is opened and closed, f) sequentially performing b) to e) until the delivery robot 1 completes delivery to all of the plurality of customers, and g) returning, the delivery robot 1, to its original position.

For example, a plurality of customers may request a supplier to deliver objects. The supplier may then load the objects requested by the plurality of customers into the plurality of drawers, such as first drawer 31, second drawer 32, and third drawer 33, of the delivery robot 1. When the supplier loads the objects into the plurality of drawers, such as first drawer 31, second drawer 32, and third drawer 33, all of the plurality of drawers, such as first drawer 31, second drawer 32, and third drawer 33, of the delivery robot 1 may be unlocked.

Then, the supplier may transmit a plurality of different open codes to the plurality of customers. In other words, the supplier may use the server 100 to transmit open codes to respective customer devices 101 and 102 of the plurality of customers (S131).

The open codes may be numbers, letters, special symbols, or combinations thereof that are capable of unlocking the drawers containing the objects requested by the customers. The plurality of open codes may be configured to match one-to-one with the plurality of drawers, such as first drawer 31, second drawer 32, and third drawer 33.

In addition, the server 100 may transmit location information of the plurality of customers to the delivery robot 1.

The delivery robot 1 may store information about the plurality of drawers, such as first drawer 31, second drawer 32, and third drawer 33, corresponding to the plurality of open codes in its memory 91. Furthermore, the delivery robot 1 may store the transmitted location information of the plurality of customers in its memory 91.

When the delivery robot 1 receives the location information of the plurality of customers, the delivery robot 1 may move to one of the plurality of customers (S132). As an example, the delivery robot 1 may calculate an optimal movement path using the location information of the plurality of customers, and then move along the calculated movement path. While the delivery robot 1 moves, all drawers, such as first drawer 31, second drawer 32, and third drawer 33, may remain locked.

The delivery robot 1 may stop upon reaching one of the plurality of customers. Thereafter, the delivery robot 1 may check whether an open code has been input (S133).

The customer may input the open code through the user interface 92 of the delivery robot 1. The user may receive the open code transmitted from the server 100 through the customer devices 101 and 102.

When the open code is input, the delivery robot 1 may operate the drawer locking device 40 to unlock a drawer corresponding to the input open code among the plurality of drawers, such as first drawer 31, second drawer 32, and third drawer 33, (S134).

In other words, the processor 90 may compare the input open code with the open codes stored in the memory 91 to search a drawer corresponding to the input open code. Thereafter, the processor 90 may control the motor 73 to move the locking plate 50 so that the locking protrusion of the drawer to be unlocked is aligned with the selection opening of the locking plate 50.

Next, the processor 90 may turn on the drawer light 95 of the unlocked drawer. Then, the customer may recognize the unlocked drawer and open it. At this time, the processor 90 may use the speaker 97 to notify that the draw is unlocked.

The delivery robot 1 may check that the unlocked drawer is open and closed (S135). The processor 90 of the delivery robot 1 may check the opening and closing of the drawer using the drawer sensor 94.

In other words, when the customer opens the drawer, the drawer sensor 94 may detect that the drawer is open. When the customer removes the object from the drawer and closes the drawer, the drawer sensor 94 may detect that the drawer is closed. Then, the processor 90 may recognize that the drawer is opened and closed using a signal transmitted from the drawer sensor 94.

When the processor 90 recognizes that the drawer is closed, the processor 90 may control the delivery robot 1 to move to the next customer.

The delivery robot 1 may stop upon reaching another customer among the plurality of customers. Thereafter, the delivery robot 1 may check whether an open code has been input.

When the open code is input, the delivery robot 1 operates the drawer locking device 40 to unlock a drawer corresponding to the input open code among the plurality of drawers, such as first drawer 31, second drawer 32, and third drawer 33.

After checking that the drawer is open and closed, the delivery robot 1 may move to the next customer.

The delivery robot 1 may sequentially perform the above-described operations until delivery is completed to all customers (S136).

When delivery to all users is completed, the delivery robot 1 may return to its original position (S137).

As described above, with the delivery robot 1 according to one or more embodiments of the disclosure, when loading objects into the plurality of drawers, such as first drawer 31, second drawer 32, and third drawer 33, all drawers, such as first drawer 31, second drawer 32, and third drawer 33, may be unlocked, and when moving, all drawers, such as first drawer 31, second drawer 32, and third drawer 33, may be locked. In addition, when the delivery robot 1 arrives at the customer, only one of the drawers, such as first drawer 31, second drawer 32, and third drawer 33, containing the customer's object may be unlocked, while the remaining drawers may be locked. Therefore, the customer may only remove his or her own object and may not see or touch the objects of other customers.

In addition, with the delivery robot 1 according to one or more embodiments of the disclosure, the customer may easily recognize the drawer containing his or her objects and remove them.

In the foregoing, the disclosure has been shown and described with reference to various embodiments. However, it is understood by those skilled in the art that various changes may be made in form and detail without departing from the scope of the disclosure as defined by the appended claims and equivalents thereof.

What is claimed is:

1. A delivery robot comprising:
a moving body;
an upper body on an upper surface of the moving body;
a plurality of drawers vertically stacked at one side of the upper body;
a drawer locking device configured to collectively lock each of the plurality of drawers and selectively unlock any one drawer of the plurality of drawers while keeping locked other drawers of the plurality of drawers; and
a processor configured to control the moving body and the drawer locking device.

2. The delivery robot of claim 1, wherein the drawer locking device comprises:
a plurality of locking protrusions on side surfaces of the plurality of drawers;
a locking plate facing the side surfaces of the plurality of drawers and comprising a plurality of locking portions configured to selectively lock and selectively unlock the plurality of locking protrusions; and
a moving part configured to move the locking plate in a vertical direction with respect to the plurality of drawers.

3. The delivery robot of claim 2, wherein each of the plurality of locking portions of the locking plate comprises:
a moving hole formed as an elongated hole that receives a corresponding locking protrusion among the plurality of locking protrusions and allows the locking plate to move in the vertical direction with respect to the plurality of locking protrusions; and
a selection opening formed at one side of the moving hole and through which the corresponding locking protrusion passes, and
wherein distances from bottom ends of the moving holes of the plurality of locking portions to the selection openings thereof are different from each other.

4. The delivery robot of claim 3, wherein the distances, from the bottom ends of the moving holes of the plurality of locking portions to the selection openings thereof, comprise a longest distance, from a lowermost bottom end of the moving hole to the selection opening of a lowermost locking portion located at a bottom of the plurality of locking portions, and a shortest distance from an uppermost bottom end of an uppermost moving hole to the selection opening of a uppermost locking portion located at a top of the plurality of locking portions, the bottom of the plurality of locking portions being of a closest locking portion, of the plurality of locking portions, to the moving body, and the top of the plurality of locking portions being of a furthest locking portion, of the plurality of locking portions, from the moving body.

5. The delivery robot of claim 3, wherein the moving holes of the plurality of locking portions comprise blocking grooves at the bottom ends of the moving holes and configured to block the plurality of locking protrusions from moving, and
wherein the moving part is configured to move the locking plate in the vertical direction with respect to the plurality of drawers and collectively lock each of the plurality of drawers by arranging, by moving the locking plate in the vertical direction until the plurality of locking protrusions at the blocking grooves of the moving holes of the plurality of locking portions.

6. The delivery robot of claim 3, wherein the moving holes of the plurality of locking portions comprise overall openings formed at tops of the moving holes and through which the plurality of locking protrusions are configured to pass, and
wherein the moving part is configured to move the locking plate in the vertical direction with respect to the plurality of drawers and collectively unlock each of the plurality of drawers by arranging, by moving the locking plate in the vertical direction, until the plurality of locking protrusions are located in the overall openings of the moving holes of the plurality of locking portions.

7. The delivery robot of claim 2, wherein the moving part comprises:
a guide member configured to guide linear movement of the locking plate; and
a driving unit configured to move the locking plate in the vertical direction.

8. The delivery robot of claim 7, wherein the driving unit comprises:
a rack gear on one side of the locking plate;
a pinion meshed with the rack gear; and
a motor configured to rotate the pinion.

9. The delivery robot of claim 7, wherein the driving unit comprises:
a ball screw on one side of the locking plate; and
a motor configured to rotate the ball screw.

10. The delivery robot of claim 7, wherein the guide member comprises a rail.

11. The delivery robot of claim 1, further comprising:
a plurality of additional drawers vertically stacked at an opposite side of the upper body, the opposite side of the upper body being opposite to the side of the upper body at which the plurality of drawers are disposed; and
an additional drawer locking device configured to collectively lock each of the plurality of additional drawers and selectively unlock any one additional drawer of the plurality of additional drawers while keeping locked other additional drawers of the plurality of additional drawers.

12. The delivery robot of claim 2, further comprising:
a user interface provided on a front of the upper body; and
a memory configured to store a plurality of open codes corresponding to the plurality of drawers,
wherein the processor is further configured to:
based on an open code being input through the user interface, determine whether the open code is included in the plurality of open codes stored in the memory, and operate the moving part to unlock the one drawer of the plurality of drawers corresponding to the open code.

13. The delivery robot of claim 2, wherein each of the plurality of locking protrusions has a same size as each other.

14. A delivery method using a delivery robot including a plurality of drawers, the delivery method comprising:
a) transmitting a different open code of a plurality of open codes to each customer of a plurality of customers;
b) moving, the delivery robot, to one of the plurality of customers;
c) checking, by the delivery robot, whether an open code of the plurality of open codes has been input;
d) operating, by the delivery robot, a drawer locking device of the delivery robot to unlock a drawer corresponding to the open code among the plurality of drawers and based on the open code being input;
e) checking, by the delivery robot, whether the drawer, that is unlocked by operating the drawer locking device, is opened and closed;
f) sequentially performing b) to e) until the delivery robot completes delivery to all of the plurality of customers; and
g) returning, the delivery robot, to a predetermined position.

15. The delivery method of claim 14, wherein the drawer locking device comprises:
a plurality of locking protrusions on side surfaces of the plurality of drawers;
a locking plate facing the side surfaces of the plurality of drawers and comprising a plurality of locking portions configured to selectively lock and selectively unlock the plurality of locking protrusions; and
a moving part configured to move the locking plate in a vertical direction with respect to the plurality of drawers.

16. The delivery method of claim 15, wherein the transmitting the different code of the plurality of open codes to each of the plurality of customers is performed by a server, and
wherein the server is configured to transmit location information of the plurality of customers to the delivery robot.
